(19) United States
(12) Patent Application Publication
(10) Pub. No.: US 2007/0009401 A1
(43) Pub. Date: Jan. 11, 2007

(54) Hybrid device for removing soot particles from diesel exhaust gases

(75) Inventors: Christian Kolbeck, Bruck/Mur (AT); Dominikos Klawatsch, Wiesen (AT)

Correspondence Address: GREENBLUM & BERNSTEIN, P.L.C., 1950 ROLAND CLARKE PLACE, RESTON, VA, 20191, US

(73) Assignee: Pankl Emission Control Systems GmbH, Kapfenberg (AT)

(21) Appl. No.: 11/416,063

(22) Filed: May 3, 2006

(30) Foreign Application Priority Data
May 4, 2005 (AT) A 771/2005

(51) Int. Cl. B01D 53/34

(52) U.S. Cl. 422/177

(57) ABSTRACT

The invention relates to a device for removing soot particles from an exhaust gas stream of a motor vehicle operated with diesel, comprising a catalyst element for the at least partial oxidation of nitrogen monoxide (NO) to nitrogen dioxide (NO₂) and a particulate filter arranged downstream of the catalyst element and means to guide the exhaust gas stream through the catalyst element and the particulate filter. So that a device of this type can be operated essentially free of clogs even with high sulfate and ash contents and quickly reaches an operating temperature with a cold start, it is provided according to the invention that the catalyst element is a coated open-porous metal foam body (1) and the particulate filter is an open-porous ceramic foam body (2).

The invention relates to a device for removing soot particles from an exhaust gas stream of a motor vehicle operated with diesel, comprising a catalyst element for the at least partial oxidation of nitrogen monoxide (NO) to nitrogen dioxide (NO₂) and a particulate filter arranged downstream of the catalyst element and means to guide the exhaust gas stream through the catalyst and the particulate filter.

Such a device has become known, e.g., from EP 0 341 832 A1, and is used in the exhaust train of diesel-operated automobiles in order to remove and to combust soot particles present in the exhaust gas as completely as possible. With this device, nitrogen monoxide (NO) present in the exhaust gas is oxidized on a catalyst element provided at least partially to nitrogen dioxide (NO₂) and/or other nitrogen oxides, such as N₂O₅, all combined in a simplified manner below under the term nitrogen dioxide. The exhaust gas thus enriched with nitrogen dioxide subsequently arrives at a particulate filter arranged downstream of the catalyst element, at which particulate filter the nitrogen dioxide reacts with soot particles that are retained by the particulate filter or at the particulate filter. Reactions can thereby run according to the reaction equations given below:

$$\begin{matrix}Catalyst element \text{:} \\ NO + \frac{1}{2} {O}_{2} ↔ {NO}_{2} & ( 1 ) \\ Particle filter \text{:} \\ 2 {NO}_{2} + C ↔ 2 NO + {CO}_{2} & ( 2 a ) \\ 2 {NO}_{2} + 2 C ↔ {N}_{2} + 2 {CO}_{2} & ( 2 b )\end{matrix}$$

The catalyst element of a known device preferably comprises a ceramic monolith that is coated with a noble metal, such as platinum, in order to achieve catalytically supported a high NO₂ formation in the exhaust gas flowing through and to optimize a reaction conversion. A downstream particulate filter comprises a wire mesh filter with a coating of lanthanium, cesium and vanadium pentoxide (La/Cs/V₂O₅), which can reduce a combustion temperature of soot particles so that they can be oxidized or combusted on the particulate filter below the so-called particulate ignition temperature (approx. 550° C.) at temperatures of 250 to 400° C.

Although it is possible with a known device to remove soot particles ideally virtually completely from a diesel exhaust gas even at low exhaust gas temperatures, this is also associated with drawbacks.

Thus it has turned out that, due to high NO₂ contents, an increased formation of sulfates from the sulfur contained in the fuel can also occur, which, alone or together with ash particles likewise present in the exhaust gas due to motor oil, can settle on the catalyst and/or particulate filter and there form larger agglomerates, since particles of this type cannot be combusted. This causes clogging in the exhaust gas treatment system, as a consequence of which a back pressure buildup occurs in the exhaust train of the motor vehicle, which leads to a drop in the engine performance.

Another drawback is that with a cold start of an engine a known device requires a long warm-up time in order to reach operating temperature and its full effect.

The invention takes up at this point, the objective of the invention being to disclose a device of the type mentioned at the outset, which can be operated essentially free of clogging even with high sulfate and ash contents in the exhaust gas and which quickly reaches an operating temperature with a cold start.

This object is achieved with a generic device in that the catalyst element is a coated open-porous metal foam body and the particulate filter is an open-porous ceramic foam body.

One advantage achieved with the invention is that on the basis of an open-porous metal foam body provided and a ceramic foam body of the same type, the entire device has a three-dimensionally multiply branched pore structure. Thus a plurality of possible flow paths are available for an exhaust gas flowing through, and potential clogs due to unoxidizable particles, in particular ash and/or sulfate particles, are effectively and continuously counteracted.

Another advantage of the invention is that exhaust gas heat can be effectively utilized. The metal foam body provided heats up very quickly during operation, which is to be attributed on the one hand to a good thermal conductivity of metals per se and on the other hand to an open-porous foam structure essentially formed by metal links freely accessible on all sides. The consequence of this is that, after a cold start of the engine, the entire surface of the metal foam body and the coating thereof within a short time already takes on a temperature of the exhaust gas or an operating temperature is reached, and an adequate generation of NO₂ according to equation (1) can occur on the coating in a catalytically supported manner

Although, compared to the upstream metal foam body, the ceramic foam body heats up more slowly, even with a cold start it can immediately perform its temperature-independent function as a particulate filter and stores heat well once absorbed due to a high heat capacity. The latter has advantages if an exhaust gas temperature drops for a short time during the operation of a motor vehicle, e.g., when the engine is operated for a certain period in the lower rpm range. Soot particles deposited on the ceramic foam body are then kept at or brought to temperature through the ceramic foam body and can thus also be combusted, although an exhaust gas temperature would not be sufficient therefor.

Another advantage of a device according to the invention is that exhaust gas flowing in in a laminar manner is agitated in the metal foam body. This formation of a turbulent flow in the metal foam body causes on the one hand an improved contact of the exhaust gas with the catalytically active coating of the metal foam body, which leads to a higher catalytic efficiency. On the other hand, the exhaust gas flows in a turbulent manner to the downstream particulate filter, and it is thus acted on with nitrogen dioxide over its cross-sectional surface in a uniform manner.

Any desired coating of the metal foam body can be given per se, as long as a nitrogen dioxide formation is catalyzed. However, a particularly effective conversion of nitrogen monoxide to nitrogen dioxide is achieved if the metal foam body is coated with a noble metal or several noble metals selected from the group comprising ruthenium, rhodium, palladium, osmium, iridium and platinum.

In principle, the ceramic foam body can be made from any desired ceramic material. As far as the highest possible mechanical loadability and thermal capacity are concerned, it is preferred for the ceramic foam body to essentially comprise an aluminum oxide, cordierite or silicon carbide.

The ceramic foam body can additionally be coated with cerium orthovanadate, Ce(III)VO₄. Cerium orthovanadate is a compound stable up to temperatures of over 2200° C., which with direct contact with soot particles can easily reduce the combustion temperature thereof to below approx. 350° C. Moreover, cerium orthovanadate is an oxygen-storing compound, so that if there is an excess of oxygen in the exhaust gas, this is temporarily stored and subsequently can be released again when there is a lack of oxidizing agents for combusting soot particles.

Alternatively, the ceramic foam body can be coated with a noble metal or several noble metals selected from the group comprising ruthenium, rhodium, palladium, osmium, iridium and platinum, in order to keep an NO₂ concentration high in the ceramic foam body.

In a particularly preferred variant, the ceramic foam body is coated with cerium orthovanadate, Ce(III)VO₄, and at least one noble metal selected from the group comprising ruthenium, rhodium, palladium, osmium, iridium and platinum. A coating of this type can be produced, for example, in that first a cerium orthovanadate coating is applied to the ceramic foam body through a wash coat or sol-gel method and this is subsequently calcined. The cerium orthovanadate coating thus applied is subsequently impregnated with a noble metal solution and optionally calcined again. Overall a cerium orthovanadate coating is thus formed in which catalytically active noble metal is present in a finely distributed manner. This means that not only is a combustion of soot particles on the ceramic foam body catalytically supported by cerium orthovanadate, but also a generation of NO₂ can occur directly on or in the coating of the ceramic foam body and sufficient oxidizing agent is available for the complete combustion of soot particles.

For analogous reasons it can also be provided for the coating of the metal foam body to contain cerium orthovanadate, Ce(III)VO₄.

The metal foam body expediently has a pore count of 3 to 50 ppi (pores per inch). If the metal foam body is embodied with a pore count of 3 to approx. 20 ppi, it is essentially permeable for soot particles and the metal foam body acts exclusively as a catalyst. If the metal foam body is embodied with a pore count of 20 to 50 ppi, soot particles can in part also be deposited thereon and combusted, so that a downstream particulate filter is relieved. This represents a particular advantage because such high temperature peaks in the particulate filter due to intensive combustion of soot particles can be avoided.

The ceramic foam body, which primarily serves to filter soot particles, has a pore count of 30 to 80 ppi in accordance with its primary function as a filter for soot particles. If a porosity of the metal foam body and the ceramic foam body is between 70 and 98% this has a favorable effect with respect to an avoidance of clogs and a rapid heating of the foam body.

In principle, a volume of the metal foam body and the ceramic foam body can be variably selected. It is favorable if the metal foam body, which should have no filter effect or a lower filter effect than the ceramic foam body, is constructed shorter and its volume is 5 to 45% of the volume of the ceramic foam body.

In order to avoid a deposit of sulfates and/or ash between the metal foam body and the ceramic foam body, it can be provided for the metal foam body to be directly connected to the ceramic foam body.

Further advantages and effects of the invention result from the context of the specification and the exemplary embodiments.

The invention is shown in further detail below on the basis of exemplary embodiments and one figure.

It shows:

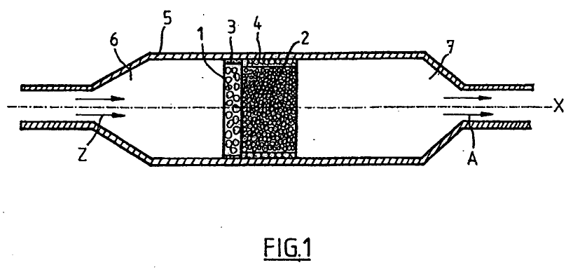

FIG. 1: A cross section of a device according to the invention parallel to the flow direction of an exhaust gas.

FIG. 1 shows in more detail in cross section a device according to the invention which is integrated into an exhaust train of a motor vehicle operated with diesel. The device comprises an open-porous metal foam body 1 coated with noble metal, which metal foam body has a porosity in the range of approx. 93% and a pore count of 40 ppi, and an open-porous ceramic foam body 2 directly connected to the metal foam body 1, the porosity of which ceramic foam body is approximately in the range of 83% and which has a pore count of 50 ppi. Both the metal foam body 1 and the ceramic foam body 2 are attached inside a housing 5 to the wall of the same. The metal foam body 1 can be connected to the housing 5, e.g., via a soldering point or a welding point 3, whereas the ceramic foam body 2 is fitted into the housing 5 by means of a bearing mat or swelling mat 4. Of course, it is also possible to attach the metal foam body 1 inside the housing 5 by means of a bearing mat or swelling mat. Compared to a metallic connection of metal foam body 1 and a metallic housing 5, this has the advantage that the metal foam is insulated in the absence of direct metallic contact with the housing 5 and therefore better stores heat once absorbed.

Apart from the connection areas necessary for a connection to the housing 5, the metal foam body 1, like the ceramic foam body 2, is adapted in its dimensions essentially to the free inner cross section of the housing 5 embodied, e.g., cylindrically in order to counteract a pressure build-up with high cleaning force as well as possible.

The housing 5, as shown in FIG. 1, can be a conventional integral part of the exhaust train of a motor vehicle, e.g., a rear muffler, and has an inlet for exhaust gas Z to be fed in and an outlet for exhaust gas A to be removed. The metal foam body 1 and the ceramic foam body 2 are arranged between inlet and outlet and together form a gas-permeable passage, through which exhaust gas Z fed in must flow completely in order to reach a gas removal area 7 from a gas feed area 6. The metal foam body 1 does not thereby act only as a catalytically active unit, but, due to its pore structure, which leads to a strong turbulence of the exhaust gas Z flowing in in an essentially laminar manner, also serves as a turbulence generator and ensures a uniform approach flow to the downstream ceramic foam body 2. In addition, with a cold start the metal foam body 1 also acts as a shield for the ceramic foam body 2: the metal foam body 1, which, like the ceramic foam body 2, initially has ambient temperature with a cold start, absorbs heat from the hot exhaust gas Z flowing in so that a gentle heating takes place of the ceramic foam body 2, which has a lower thermal shock resistance and should not be exposed to large temperature changes, if possible.

A metal foam body according to FIG. 1 preferably comprises an iron-base alloy that has a high resistance to corrosion and a good thermal stability. Alloys that meet these requirements are AISI 314 (DIN material no. 1.4841) or FeCrAlY alloys (e.g., with a composition, in percent by weight, of 20 to 25% chromium, 5 to 20% aluminum, up to 1% manganese, up to 1% silicon, up to 1% yttrium, up to 0.77% carbon, the residue being iron and contaminants due to manufacture). The ceramic foam body can be composed, e.g., of cordierite, Mg₂Al₃[AlSi₅O₁₈]. A production of the metallic or ceramic foam bodies can be carried out in that an open-porous polyurethane foam with precisely defined pore size is impregnated with a suspension of metal or ceramic powder, water, binder, antifoamants, dispersing agents and optionally other additives, and is subsequently dried and then sintered under inert gas, whereby the polyurethane foam serving as a negative is burnt out. Subsequently a desired coating is applied.

Devices of the type described above were tested together with comparison devices with respect to their properties during operation; detailed data on the devices tested are provided in Table 1.

Exhaust gas of a diesel engine was fed to all the devices listed in Table 1 for the same test duration (50 hours) and under the same conditions. The diesel engine was thereby loaded in all the tests according to a specific standardized driving cycle, and devices 1 through 6 were tested during and after operation with respect to their operating performance, whereby the following results were obtained:

During operation, a soot trapping rate or removal rate for soot particles of at least 70% by weight and a conversion of soot constituents of the exhaust gas in the range of at least 95% were detected for all the devices, so that corresponding minimum requirements for a soot particle removal can be met by all devices.

In contrast to the devices 4 through 6, an improved operating performance was given with a cold start with the devices 1 through 3 according to the invention. Thus directly after a cold start a lower soot particle discharge and lower NO concentrations on the outlet side were detected with the devices 1 through 3, which already indicates an effective conversion according to equation 1 and 2 only shortly after the engine startup. In this connection it also seems to be decisive that catalysts of the devices 1 through 3, as temperature measurements at the same have shown, quickly heat up to exhaust gas temperature, whereas with catalysts of the devices 4 through 6 this heating was delayed in comparison.

After the test duration of 50 hours, the devices were tested for unburnt residue, in particular sulfate and ash residue, with the aid of light-microscopical and analytical techniques. It was thereby shown that perceptible proportions of ash and sulfate residue were present in the devices 4 through 6, whereas the devices 1 through 3 were virtually free of such residue. This shows that devices 1 through 3 according to the invention are suitable for the continuous removal and combustion of soot particles from exhaust gas in lengthy operation without there being any danger of clogging by ash and/or sulfate particles.

In the following table 1, structure of devices 1 through 6 and the test results obtained with these devices have been qualitatively combined.

TABLE 1

| | Example | | | | | |
|---|---|---|---|---|---|---|
| | 1 (invention) | 2 (invention) | 3 (invention) | 4 (comparison) | 5 (comparison) | 6 (comparison) |
| Catalyst element | Coated metal foam | Coated metal | Coated metal | Ceramic DOC* | Ceramic DOC* | Ceramic DOC* |
| | body | foam body | foam body | | | |
| Composition | FeCr₂₅Ni₂₀Si₂Mn₁ | FeCr₂₃Al₆Y_{0.2} | FeCr₂₃Al₁₀Y_{0.4} | Cordierite | Cordierite | Cordierite |
| Volume [dm³] | 12 | 12 | 9 | 8 | 12 | 12 |
| Pore count [ppi] | 30 | 40 | 40 | 400 cpsi** | 300 cpsi** | 400 cpsi** |
| Porosity {%} | 93 | 93 | 93 | 20 | 20 | 20 |
| Coating | Pt | Pt | Pt/Pd | Pt | Pt | Pt |
| Particulate filter | Ceramic foam body | Ceramic foam | Ceramic foam | Ceramic wall flow | Ceramic foam | Sintered metal |
| | | body | body | filter | body | |
| Composition | Cordierite | Cordierite | Al₂O₃ | Cordierite | Al₂O₃ | FeCrAlY |
| Volume [dm³] | 8 | 8 | 12 | 12 | 8 | 10 |
| Pore count [ppi] | 50 | 50 | 50 | 200 cpsi | 50 | — |
| Porosity [%] | 83 | 83 | 83 | 50 | 83 | 60 |
| Coating | — | Pt | Ce(III)VO₄/Pt | — | — | — |
| Residue | A | A | A | E | D | D |
| (sulfate/ash | | | | | | |
| residue | | | | | | |
| Efficiency | B | B | A | E | E | E |
| immediately after | | | | | | |
| cold start | | | | | | |
| Heat management | A | A | A | C | D | D |
| behavior | | | | | | |

*DOC ... commercial diesel oxidation catalyst,
**cpsi ... cells per square inch
Scale A through E:
A . . . excellent, B . . . good, C . . . satisfactory, D . . . still suitable, E . . . not acceptable.

Naturally, within the scope of the invention it is also possible to connect several devices according to the invention in parallel or in series, in order to optimize an exhaust gas cleaning. It is also possible to utilize the electric conductivity of the metal foam body and to heat it with low energy expenditure.

1. Device for removing soot particles from an exhaust gas stream of a motor vehicle operated with diesel, comprising a catalyst element for the at least partial oxidation of nitrogen monoxide (NO) to nitrogen dioxide (NO₂) and a particulate filter arranged downstream of the catalyst element and means to guide the exhaust gas stream through the catalyst element and the particulate filter, characterized in that the catalyst element is a coated open-porous metal foam body (1) and the particulate filter is an open-porous ceramic foam body (2).

2. Device according to claim 1, characterized in that the metal foam body (1) is coated with a noble metal or several noble metals selected from the group comprising ruthenium, rhodium, palladium, osmium, iridium and platinum.

3. Device according to claim 1, characterized in that the ceramic foam body (2) essentially comprises an aluminum oxide, cordierite or silicon carbide.

4. Device according to claim 1, characterized in that the ceramic foam body (2) is coated with cerium orthovanadate, Ce(III)VO₄.

5. Device according to claim 1, characterized in that the ceramic foam body (2) is coated with a noble metal or several noble metals selected from the group comprising ruthenium, rhodium, palladium, osmium, iridium and platinum.

6. Device according to claim 1, characterized in that the ceramic foam body (2) is coated with cerium orthovanadate, Ce(III)VO₄, and at least one noble metal selected from the group comprising ruthenium, rhodium, palladium, osmium, iridium and platinum.

7. Device according to claim 1, characterized in that the coating of the metal foam body (1) contains cerium orthovanadate, Ce(III)VO₄.

8. Device according to claim 1, characterized in that the metal foam body (1) has a pore count of 3 to 50 ppi.

9. Device according to claim 1, characterized in that the ceramic foam body (2) has a pore count of 30 to 80 ppi.

10. Device according to claim 1, characterized in that a porosity of the metal foam body (1) and the ceramic foam body (2) is between 70 and 98%.

11. Device according to claim 1, characterized in that a volume of the metal foam body (1) is 5 to 45% of the volume of the ceramic foam body (2).

12. Device according to claim 1, characterized in that the metal foam body (1) is directly connected to the ceramic foam body (2).
